(19) United States
(12) Patent Application Publication
(10) Pub. No.: US 2026/0228905 A1
(43) Pub. Date: Aug. 6, 2026

(54) IMAGE PROCESSING DEVICE AND IMAGE PROCESSING METHOD

(71) Applicant: SK hynix Inc., Icheon-si (KR)

(72) Inventor: Ji Hee HAN, Icheon-si (KR)

(21) Appl. No.: 19/383,332

(22) Filed: Nov. 7, 2025

(30) Foreign Application Priority Data
Feb. 6, 2025 (KR) 10-2025-0015047

(51) Int. Cl. G06T 7/521; G01B 11/22; G01S 7/484; G01S 7/4865; G01S 17/89

(52) U.S. Cl. CPC G06T 7/521; G01B 11/22; G01S 7/484; G01S 7/4865; G01S 17/89; G06T 2207/10028; G06T 2207/20072

(57) ABSTRACT

An image processing device and an image processing method are disclosed. The image processing device include: a coarse histogram generator configured to receive first image data generated in response to light of first light pulses that is directed to illuminate, and is reflected from, a target object and generate a first coarse histogram based on the first image data; a depth information generator in communication with the coarse histogram generator to receive the first coarse histogram and configured to generate first depth information based on the first coarse histogram; and a light source controller in communication with the depth information generator to receive the first depth information and configured to determine a first shot number of second light pulses that are to be directed to the target object based on the first depth information.

### CROSS-REFERENCE TO RELATED APPLICATION

This patent document claims the priority and benefits of Korean patent application No. 10-2025-0015047, filed on February 06, 2025, the disclosure of which is incorporated herein by reference in its entirety as part of the disclosure of this patent document.

### TECHNICAL FIELD

The technology and implementations disclosed in this patent document generally relate to an image processing device and an image processing method.

### BACKGROUND

Image sensing devices capture optical images by converting light into electrical signals using photosensitive semiconductor materials which react to light. With advances in the automotive, medical, computer and communication industries, the demand for high-performance image sensing devices is growing across various fields such as smartphones, digital cameras, game machines, IoT (Internet of Things), robots, security cameras and medical micro cameras.

Image sensing devices may be used to acquire color images or sense the distance to a target object to be captured. Recently, a time-of-flight (ToF) method, which directly or indirectly measures a time duration in which light is reflected from the target object and returns to the image sensing device, has been widely used.

### SUMMARY

Various embodiments of the disclosed technology relate to an image processing device that determines the number of laser shots to be emitted based on depth information.

Various embodiments of the disclosed technology relate to an image processing device that utilizes a coarse histogram or a fine histogram when generating depth information.

Various embodiments of the disclosed technology relate to an image processing device that obtains depth information by emitting lasers and detecting the emitted lasers based on the determined number of laser shots.

Various embodiments of the disclosed technology relate to an image processing device that determines an optimal number of laser shots for generating a coarse histogram and an optimal number of laser shots for generating a fine histogram.

In accordance with an embodiment of the disclosed technology, an image processing device may include: a coarse histogram generator configured to receive first image data generated in response to light of first light pulses that is directed to illuminate, and is reflected from, a target object and generate a first coarse histogram based on the first image data; a depth information generator in communication with the coarse histogram generator to receive the first coarse histogram and configured to generate first depth information based on the first coarse histogram; and a light source controller in communication with the depth information generator to receive the first depth information and configured to determine a first shot number of second light pulses that are to be directed to the target object based on the first depth information.

In some implementations, the image processing device may further include: a fine histogram generator configured to generate a first fine histogram based on the first coarse histogram and second image data generated in response to the second light pulses reflected from the target object, wherein the depth information generator generates second depth information using the first fine histogram.

In some implementations, the light source controller may be configured to determine a second shot number of third light pulses to be directed to the target object and a third shot number of fourth light pulses to be directed to the target object based on the second depth information.

In some implementations, the coarse histogram generator may be configured to is configured to generate a second coarse histogram based on third image data generated in response to the third light pulses reflected from the target object; and the fine histogram generator is configured to generate a second fine histogram based on the second coarse histogram and fourth image data generated in response to the fourth light pulses reflected from the target object.

In some implementations, the depth information generator may generate third depth information based on the second fine histogram.

In some implementations, the light source controller may be configured to: determine the second shot number of the third light pulses to be a value equal to or greater than a first threshold, upon determining that the target object is located within a predetermined long-distance range based on the second depth information.

In some implementations, the light source controller may be configured to determine the first shot number of the second light pulses to be a value less than a second threshold, upon determining that the target object is located within a predetermined short-distance range based on the first depth information; and determine the first shot number of the second light pulses to be a value equal to or greater than the second threshold, upon determining that the target object is located within a predetermined long-distance range based on the first depth information.

In some implementations, the light source controller may be configured to determine the first shot number of the second light pulses according to the first depth information by referring to a pre-stored lookup table.

In some implementations, the light source controller may be configured to determine the first shot number of the second light pulses based on depth accuracy or depth error.

In accordance with another embodiment of the present disclosure, an image processing device may include: a coarse histogram generator configured to receive first image data generated in response to detection of reflection of first light pulses generated by a light source that is directed to illuminate, and is reflected from, a target object and generate a first coarse histogram based on the first image data; a fine histogram generator in communication with the coarse histogram generator to receive the first coarse histogram and configured to generate a first fine histogram based on the first coarse histogram and second image data generated in response to detection of reflection of second light pulses generated by the light source from the target object; a depth information generator in communication with the fine histogram generator to receive the first fine histogram and configured to generate first depth information based on the first fine histogram; and a light source controller in communication with the depth information generator to receive the first depth information and configured to determine a first shot number of third light pulses and a second shot number of fourth light pulses based on the first depth information.

In some implementations, the coarse histogram generator may be configured to generate a second coarse histogram based on third image data generated in response to the third light pulses reflected from the target object; and the fine histogram generator is configured to generate a second fine histogram based on the second coarse histogram and fourth image data generated in response to the fourth light pulses reflected from the target object.

In some implementations, the depth information generator may generate second depth information based on the second fine histogram.

In some implementations, the light source controller may be configured to determine the first shot number of the third light pulses to be a value equal to or greater than a first threshold, upon determining that the target object is located within a predetermined long-distance range based on the first depth information.

In some implementations, the light source controller may be configured to determine the second shot number of the fourth light pulses to be a value less than a second threshold, upon determining that the target object is located within a predetermined short-distance range based on the first depth information; and determine the second shot number of the fourth light pulses to be a value equal to or greater than the second threshold, when the first depth information is included in a predetermined long-distance range.

In some implementations, the light source controller may be configured to determine the first shot number of the third light pulses to be emitted by the light source and the second shot number of the fourth light pulses to be emitted by the light source, based on a pre-stored lookup table.

In some implementations, the light source controller is configured to: determine the first shot number of the third light pulses to be emitted by the light source and the second shot number of the fourth light pulses to be emitted by the light source, based on depth accuracy or depth error.

In accordance with another embodiment of the present disclosure, an image processing device may include: a coarse histogram generator configured to receive first image data generated in response to first light pulses reflected from a target object and generate a first coarse histogram based on first image data; a depth information generator in communication with the coarse histogram generator to receive the first coarse histogram and configured to generate first depth information based on the first coarse histogram; and a light source controller in communication with the depth information generator to receive the first depth information and configured to determine a first shot number of second light pulses and a second shot number of third light pulses based on the first depth information.

In some implementations, the coarse histogram generator may be configured to: generate a second coarse histogram based on second image data generated in response to the second light pulses reflected from the target object.

In some implementations, the image processing device may further comprise: a fine histogram generator configured to generate a fine histogram based on the second coarse histogram and third image data generated in response to the third light pulses reflected from the target object.

In some implementations, the depth information generator may generate second depth information based on the fine histogram.

It is to be understood that the foregoing general description and the following detailed description of the disclosed technology are illustrative and explanatory.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an imaging system based on some embodiments of the disclosed technology.

FIG. 2 is a flowchart illustrating an example of an image processing method based on some embodiments of the disclosed technology.

FIGS. 3A to 3C are exemplary diagrams illustrating an example of an image processing method based on some embodiments of the disclosed technology.

FIGS. 4A and 4B are exemplary diagrams illustrating an example of an image processing method based on some embodiments of the disclosed technology.

FIG. 5 is a flowchart illustrating an example of an image processing method based on some embodiments of the disclosed technology.

FIG. 6 is a flowchart illustrating an example of an image processing method based on some embodiments of the disclosed technology.

FIG. 7 is a flowchart illustrating an example of an image processing method based on some embodiments of the disclosed technology.

FIG. 8 is a flowchart illustrating an example of an image processing method based on some embodiments of the disclosed technology.

FIG. 9 is a conceptual diagram illustrating an example of an image processing method based on some embodiments of the disclosed technology.

FIG. 10 is a block diagram showing an example of a computing device corresponding to the image processing device of FIG. 1 based on some embodiments of the disclosed technology.

### DETAILED DESCRIPTION

This patent document provides implementations and examples of an image processing device and an image processing method that may be used in configurations to substantially address one or more technical or engineering issues and to mitigate limitations or disadvantages encountered in some other image processing devices. Some implementations of the disclosed technology relate to an image processing device that determines the number of laser shots to be emitted based on depth information. Some implementations of the disclosed technology relate to an image processing device that utilizes a coarse histogram or a fine histogram when generating depth information. Some implementations of the disclosed technology relate to an image processing device that obtains depth information by emitting lasers and detecting the emitted lasers based on the determined number of laser shots. Some implementations of the disclosed technology relate to an image processing device that determines an optimal number of laser shots for generating a coarse histogram and an optimal number of laser shots for generating a fine histogram. In recognition of the issues above, the disclosed technology may provide an image processing device that may improve depth measurement accuracy by emitting lasers with different numbers of laser shots according to depth information. The disclosed technology may provide an image processing device that may generate depth information using a coarse histogram or a fine histogram. The disclosed technology may provide an image processing device that may emit lasers based on the determined number of laser shots and calculate a depth by detecting the emitted lasers. The disclosed technology may provide an image processing device that may determine an optimal number of laser shots for generating a coarse histogram and an optimal number of laser shots for generating a fine histogram.

Hereinafter, various implementations embodiments will be described with reference to the accompanying drawings. It should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

Hereinafter, embodiments of the disclosed technology will be described in detail with reference to the accompanying drawings. The disclosed technology may be implemented in various different forms and is not limited to the embodiments described herein.

In the following description of embodiments of the disclosed technology, a detailed description of known functions and configurations incorporated herein will be omitted when it may make the subject matter of the present disclosure rather unclear. In the drawings, parts that are not related to a description of the present disclosure are omitted to clearly explain the disclosed technology and similar reference numbers will be used throughout this specification to refer to similar parts.

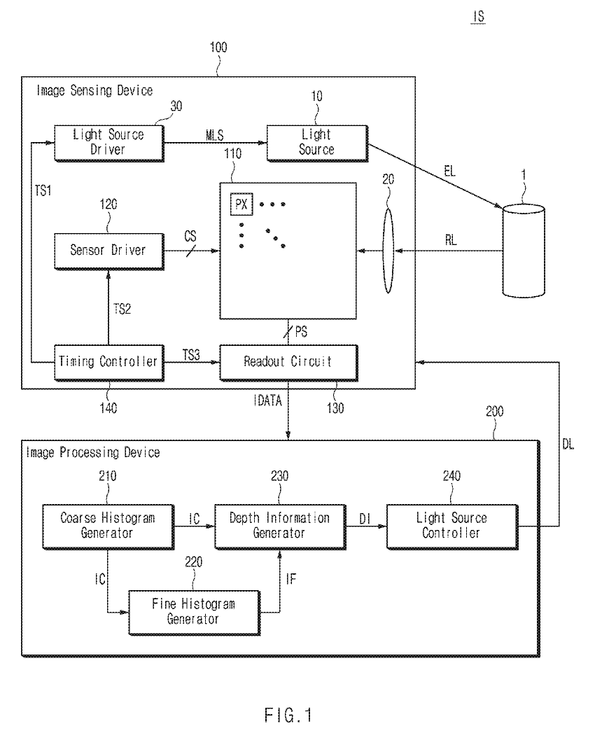

Hereinafter, exemplary embodiments of the disclosed technology will be described in detail with reference to FIGS. 1 to 10.

FIG. 1 is a block diagram illustrating an example of an imaging system (IS) based on some embodiments of the disclosed technology.

Referring to FIG. 1, the imaging system (IS) may be implemented as a device, for example, a digital still camera for photographing still images or a digital video camera for photographing moving images. For example, the imaging system (IS) may be implemented as various devices, including a Digital Single Lens Reflex (DSLR) camera, a mirrorless camera, or a smartphone,. The imaging system (IS) may include a device having both a lens and an image pickup element such that the device can capture (or photograph) a target object and can thus create an image of the target object. For example, the imaging system (IS) may be implemented as a Lidar sensor.

The imaging system (IS) may include an image sensing device 100 and an image processing device 200 in the example of an imaging system (IS) in FIG. 1.

The image sensing device 100 may be or include a complementary metal oxide semiconductor image sensor (CIS) for converting an incident light into an electrical signal. The image sensing device 100 may include a light source 10, a lens module 20, a light source driver 30, a pixel array 110, a sensor driver 120, a readout circuit 130, and a timing controller 140.

The light source 10 may emit light with light pulses (or laser shots or pulses when the emitted light is laser light) to a target object 1 upon receiving a modulation light signal (MLS) from the light source driver 30. Such modulated light with light pulses emitted by the light source 10 towards the target object carries timestamps with the light pulses and the detection of the reflected light pulses from the target object can be used to measure the time of flight (TOF) from the image sensing device 100 to the target object and back to the image sensing device 100 and this TOF measurement can be used to determine the distance between the image sensing device 100 and the target object. In some implementations, the light source 10 may be implemented as a laser diode (LD) or a light emitting diode (LED). The light source 10 may be configured to emit light in a specific wavelength band, e.g., near infrared (NIR) light, infrared (IR) light, or visible light. In some implementations, the light source 10 may be another type of device, such as a Near Infrared (NIR) Laser, a point light source, a monochromatic light source (e.g., a white lamp combined with a monochromator), or a combination of other laser sources. For example, the light source 10 may emit infrared light having a wavelength of 800 nm to 1000 nm. In the example, light emitted from the light source 10 may be pulsed with a predetermined period, amplitude, and pulse width. Although FIG. 1 shows only one light source 10 for convenience of description, other implementations are also possible., For example, a plurality of light sources may be arranged in the vicinity of the lens module 20.

In some implementations, the light source 10 may be a dot light source that concentrates the emitted light onto multiple points. The dot light source may be implemented by combining optical systems such as lenses or diffractive optical elements (DOEs) with a laser diode, thereby enabling spot light at multiple points. Because the spot lights produced by the dot light source have a profile with some scalability from the optical constraints, such spot lights may be irradiated across multiple pixels (PXs).

The lens module 20 may collect light reflected from the target object 1, and may allow the collected light to be focused onto pixels (PXs) of the pixel array 110. For example, the lens module 20 may include a lens, such as a focusing lens or a cylindrical optical element, which includes glass or plastic and. In some implementations, the lens module 20 may include a plurality of lenses that is arranged to be focused upon an optical axis.

The light source driver 30 may generate the modulation light signal (MLS) for driving the light source 10 in response to a timing signal (TS1) of the timing controller 140. In some implementations, the light source driver 30 may control waveforms (e.g., a period, amplitude, pulse width, etc.) of emitted light (EL) output from the light source 10.

The pixel array 110 may include a plurality of pixels (PXs) consecutively arranged in a two-dimensional (2D) matrix structure (e.g., consecutively arranged in a column direction and/or a row direction). Each of the plurality of pixels (PXs) may generate a pixel signal by sensing incident light received through the lens module 20 based on the control of the sensor driver 120. The pixel array 110 may include a color filter array (CFA) in which color filters are arranged in a predetermined pattern (e.g., a Bayer pattern, a quad-Bayer pattern, non-Bayer pattern, or an RGBW pattern, etc.) so that each color filter can sense light of a predetermined wavelength band. The pattern of the image data (IDATA) may be determined according to the type of the pattern of the CFA.

Each pixel (PX) may be an infrared pixel for generating a pixel signal by sensing incident light that includes reflected light (RL) generated when emitted light (EL) from the light source 10 is reflected from the target object 1. Although the present embodiment assumes that the reflected light (RL) is light that is reflected from the target object 1 and incident upon the pixel array 110 for convenience of description, other implementations are also possible. The pixels (PXs) can be configured for various functions. In some implementations, the infrared pixel may function as a depth pixel for calculating the distance to the target object 1. In some implementations, the infrared pixel may include a pixel for generating an infrared image by sensing infrared light from a scene, rather than reflected light. In some implementations, the pixels (PXs) may include a pixel for generating a color image by sensing visible light from a scene.

The sensor driver 120 may drive the pixels (PXs) of the pixel array 110 in response to a timing signal (TS2) output from the timing controller 140. For example, the sensor driver 120 may generate a control signal capable of selecting and controlling pixels (PXs) included in at least one row line from among a plurality of row lines of the pixel array 110.

The readout circuit 130 may process pixel signals (PS) received from the pixel array 110 in response to a timing signal (T3) of the timing controller 140, and may thus generate and store image data (IDATA) for detecting the distance to the target object 1. The image data (IDATA) may be digital data obtained by performing analog-to-digital conversion (ADC) on an analog pixel signal. To this end, the readout circuit 130 may include a correlated double sampler (CDS) circuit for performing correlated double sampling (CDS) on the pixel signals generated from the pixel array 110. In addition, the readout circuit 130 may include an analog-to-digital converter (ADC) for converting output signals of the CDS circuit into digital signals. In addition, the readout circuit 130 may include a buffer circuit that temporarily stores pixel data generated from the analog-to-digital converter (ADC) and outputs the pixel data under control of the timing controller 140. In the meantime, two column lines for transmitting the pixel signal may be assigned to each column of the pixel array 110, and structures for processing the pixel signal generated from each column line may be configured to correspond to the respective column lines.

The timing controller 140 may generate timing signals (TS1, TS2, TS3) to control the light source driver 30, the sensor driver 120, and the readout circuit 130. In some implementations, the timing controller 140 may generate a timing signal according to either a predetermined setting value and/or a request received from the image processing device 200. In some implementations, the timing controller 140 may include at least one of a logic control circuit, a phase locked loop (PLL) circuit, a timing control circuit, a communication interface circuit, or others.

The image processing device 200 may be provided to be in communication with the image sensing device 100. The image processing device 200 may receive the image data (IDATA) from the image sensing device and perform at least one image signal process on image data (IDATA) to generate the processed image data.

The image processing device 200 may reduce noise of image data (IDATA), and may perform various kinds of image signal processing (e.g., demosaicing, defect pixel correction, gamma correction, color filter array interpolation, color matrix, color correction, color enhancement, or lens distortion correction, etc.) for improving the image quality of the image data. In addition, the image processing device 200 may compress image data that has been created by execution of image signal processing for image-quality improvement, such that the image processing device 200 can create an image file using the compressed image data. Alternatively, the image processing device 200 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or others can be used. In the case of using moving images, a plurality of frames can be compressed according to Moving Picture Experts Group (MPEG) standards for creating moving image files.

In the example, the image processing device 200 may be mounted on a chip that is independent from the chip on which the image sensing device 100 is mounted. However, the disclosed technology is not limited thereto. For example, the image processing device 200 and the image sensing device 100 can be integrated onto a chip or the image processing device 200 and the image sensing device 100 can be vertically stacked while being manufactured separately from each other. The chip provided with the image sensing device and the chip provided with the image processing device 200 can communicate with each other through a predetermined interface. In one embodiment, the chip on which the image sensing device is mounted and the chip on which the image processing device 200 is mounted may be implemented in one package, for example, a multi-chip package (MCP), but other implementations are also possible.

The image processing device 200 may include a coarse histogram generator 210, a fine histogram generator 220, a depth information generator, and/or a light source controller 240 such as a laser controller when the light source 10 is implemented by a laser.

The coarse histogram generator 210 may generate a coarse histogram required to generate depth information(DI). The coarse histogram may be a histogram in which bin numbers corresponding to the detected times-of-flight (ToFs) of the lasers or laser pulses are depicted on an X-axis and count values of the detected lasers are depicted on a Y-axis. In the example, each bin represents a time interval and the number of the detected lasers corresponding to the windows of times are counted. In some implementations, when photons reflected from a target object are detected by the pixel array, the TOF sensor assigns a timestamp to each detected photon. These timestamp values are quantized and accumulated in corresponding time bins, where each bin represents a discrete time interval within the measurement window. The coarse histogram generator 210 counts the number of photon detection events in each time bin to generate a histogram of photon arrivals. In some implementations, the coarse histogram generator 210 may generate the coarse histogram based on the detected lasers. The coarse histogram generator 210 may generate a coarse histogram based on image data (IDATA), which is generated when the lasers emitted from the light source 10 are reflected by the target object and detected by the pixels, and may transmit information (IC) about the coarse histogram to the fine histogram generator 220 or the depth information generator 230. The coarse histogram may include a peak bin having the highest count value. In the example, the peak bin may represent the most probable arrival times of reflected light. The depth information generator 230 may generate depth information (DI) based on the time-of-flight (ToF) corresponding to the peak bin. For example, the depth information generator 230 may generate the depth information (DI) by multiplying the ToF corresponding to the peak bin by the speed of light.

The fine histogram generator 220 may generate a fine histogram for depth generation. For example, the fine histogram generator 220 may generate the fine histogram based on the detected lasers and the coarse histogram. In the example, the fine histogram generator 220 may generate the fine histogram based on not only image data (IDATA) generated when lasers emitted from the light source 10 are reflected by the target object and detected by the pixels, but also the coarse histogram. The fine histogram may be a histogram in which the peak bin of the coarse histogram is divided into multiple bins, and the count values of the detected lasers are mapped to the multiple bins. The fine histogram generator 220 may generate a fine histogram in which bin numbers corresponding to the times-of-flight (ToFs) of the detected lasers are depicted on the X-axis and the count values of the detected lasers are depicted on the Y-axis. In the example, after the light source 10 emits first lasers, a coarse histogram may be created based on the first lasers reflected by the target object and detected by the pixels; and subsequently, the light source 10 emits second lasers, a fine histogram may be created based on detecting by the pixels the reflection of the second lasers by the target object. Thus, the fine histogram generator 220 uses the previously generated coarse histogram in response to reflection of the first lasers and a new set of image data (IDATA), which is generated in response to the reflection of the second lasers, to create the fine histogram. The fine histogram generator 220 may transmit information (IF) about the fine histogram to the depth information generator 230. The fine histogram may include a peak bin with the highest count value, and the depth information generator 230 may generate depth information (DI) based on the ToF corresponding to the peak bin. For example, the depth information generator 230 may generate the depth information (DI) by multiplying the ToF corresponding to the peak bin by the speed of light. In a situation where the fine histogram is created by dividing the bins of the coarse histogram more finely, when depth information (DI) is generated based on the fine histogram, more accurate depth information (DI) may be obtained than other depth information (DI) created using only the coarse histogram.

The depth information generator 230 may generate depth information (DI) using either the coarse histogram or the fine histogram as described above. For example, the depth information generator 230 may generate the depth information (DI) by multiplying the time-of-flight (ToF) corresponding to either the peak bin of the coarse histogram or the peak bin of the fine histogram by the speed of light.

The light source controller 240 (e.g., a laser controller) may determine the number of light pulses such as laser shots to be emitted by the light source 10 based on depth information (DI). In some implementations, the light source controller 240 dynamically determines the number of light pulses or laser shots the light source 10 emits, creating a feedback loop between the image sensing device 100 and the image processing device 200. In some implementations, the light source 10 emits an initial set of lasers, which are reflected by the target object and detected by the pixels. This data is used to generate the depth information (DI). The initial set of lasers may be predetermined as an initial value. In the example, the initial value can be obtained based on the previous depth information of the target object. The light source controller 240 may analyze the depth information (DI) to generate data (DL) representing the number of light pulses or laser shots based on the depth information (DI). The data (DL) regarding the number of light pulses or laser shots may be input to the timing controller 140 or the light source driver of the image sensing device 100. In the example, the light source 10 may emit as many lasers as the determined number of light pulses or laser shots. For example, the light source controller 240 may determine the number of light pulses or laser shots for generating the coarse histogram as 10000 and may determine the number of light pulses or laser shots for generating the coarse histogram as 25000, so that the light source 10 may emit lasers based on the determined number of light pulses or laser shots. Thus, the image sensing device 100 may emit lasers through the light source 10 based on the number of laser shots determined by the light source controller 240. The emitted lasers may be reflected by the target object and detected by pixels. Based on the detected lasers, the light source controller 240 may determine the number of laser shots to be emitted by the light source controller 240. The light source 10 may emit lasers again based on the determined number of laser shots, so that the image processing device 200 and the image sensing device 100 may have a feedback structure. Although FIG. 1 illustrates the light source controller 240 as being included in the image processing device 200, the light source controller 240 according to an exemplary embodiment of the disclosed technology may also be included in the image sensing device 100.

The light source controller 240 may determine the number of light pulses or laser shots to be emitted based on the depth information (DI). In some implementations, the light source controller 240 may use different thresholds for the coarse histogram and the fine histogram. For example, when the measured depth is included in a preset long-distance range (e.g., a range of 8 meters or more), the light source controller 240 may determine the number of laser shots for generating the coarse histogram to be equal to or greater than a first threshold. In some implementations, when the measured depth is included in a preset short-distance range (e.g., a range between 40 centimeters and 8 meters), the light source controller 240 may determine the number of laser shots for generating the fine histogram as a value less than a second threshold, and when the measured depth is included in the preset long-distance range, the light source controller 240 may determine the number of laser shots for generating the fine histogram as a value equal to or greater than the second threshold. However, other implementations are also possible. For instance, in a situation where the object’s depth is determined to be 3 meters, the light source controller 240 may set the number of laser shots for generating the coarse histogram to 10,000 and may set the number of laser shots for generating the fine histogram to 25,000. In a situation where the object’s depth is determined to be 9 meters, the light source controller 240 may set the number of laser shots for generating the coarse histogram to 20,000 and may set the number of laser shots for generating the fine histogram to 50,000. In the example, the light source controller 240 may use a relatively higher number of shots for the long-distance range, thereby increasing the accuracy. Also, the light source controller 240 may use a relatively lower number of shots to generate the fine histogram for the short-distance range, thereby increasing the accuracy. The above-described numerical values are merely examples for convenience of description and better understanding of the disclosed technology, and the number of laser shots is not limited thereto.

The light source controller 240 may determine the number of laser shots to be emitted based on the depth information (DI) as an optimal value for increasing depth measurement accuracy. For example, the light source controller 240 may determine the number of laser shots to be emitted by the light source 10 based on depth accuracy or depth error. The “depth accuracy” may represent a numerical value indicating how precisely the imaging system (IS) can measure the depth of a target object. A smaller depth accuracy value may correspond to higher depth measurement accuracy, but other implementations are also possible. The “depth error” may indicate the degree to which the depth measured by the imaging system (IS) deviates from the actual depth. A smaller depth error value may correspond to higher measurement accuracy, but other implementations are also possible. More specific details regarding the method for determining the number of laser shots to be emitted based on depth accuracy and depth error will be described later with reference to the attached drawings.

The light source controller 240 may determine the number of laser shots to be emitted by the light source 10 based on the depth by using a pre-stored lookup table. In some implementations, the light source controller 240 may determine the number of laser shots using a lookup table that includes optimal numbers of laser shots that are designed to maximize depth accuracy or minimize depth error. A more detailed description regarding the method of determining the number of laser shots will be provided later with reference to the attached drawings.

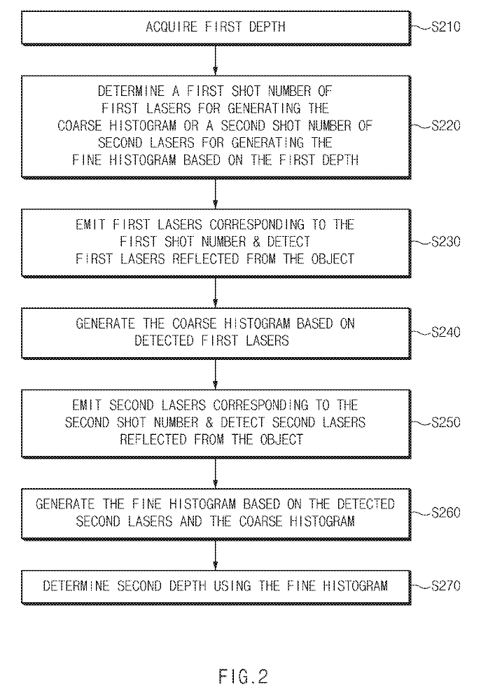

FIG. 2 is a flowchart illustrating an example of an image processing method based on some embodiments of the disclosed technology.

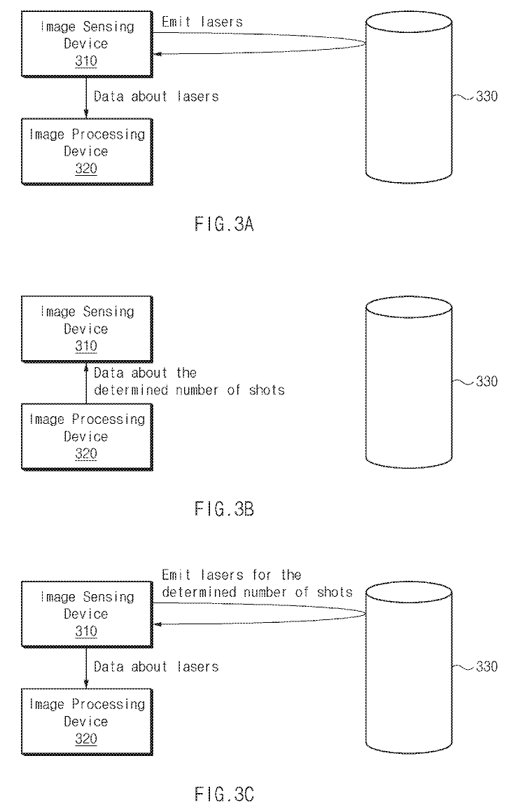

FIGS. 3a to 3c are diagrams illustrating an example of an image processing method based on some embodiments of the disclosed technology.

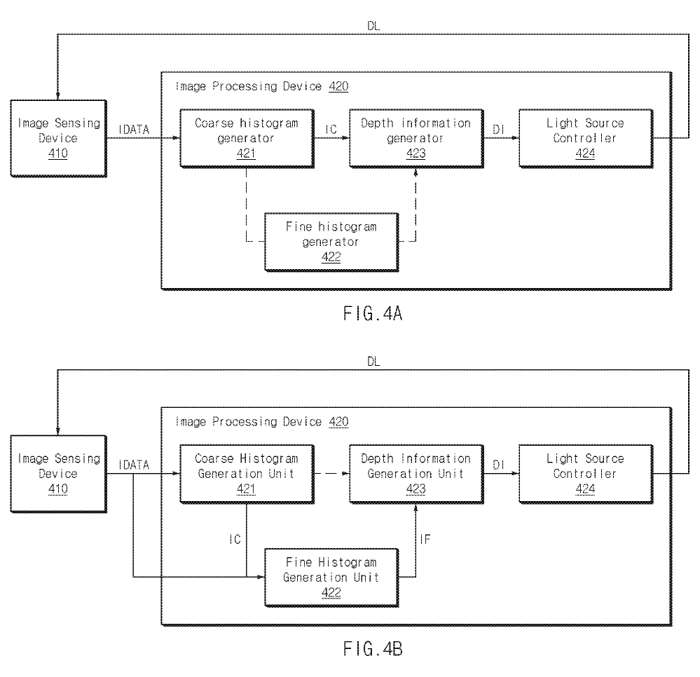

FIGS. 4a and 4b are diagrams illustrating an example of an image processing method based on some embodiments of the disclosed technology.

Hereinafter, the embodiment of FIG. 2 will be described with reference to FIGS. 3a to 4b.

Referring to FIG. 2, the image processing method according to an exemplary embodiment of the disclosed technology may acquire a first depth (Operation S210). Hereinafter, the depth may refer to depth information of a target object. In the example, the first depth may be used to optimize the number of laser shots for a subsequent, more accurate measurement. The image processing method may improve depth measurement accuracy by setting different numbers of laser shots to be emitted based on the depth. In the example, the image processing method may acquire a first depth of a target object at a first time point. In the example, the first depth at the first time point may be utilized to determine the optimal number of laser shots to be emitted at a second time point which is later than the first time point. The first depth may be obtained by emitting lasers based on predetermined shot numbers, detecting lasers reflected by the target object, generating a coarse histogram or a fine histogram based on the detected lasers, and calculating a depth using the coarse histogram or the fine histogram. For example, referring to FIG. 3a, the image sensing device 310 may emit lasers toward a target object 330. In the example, the preset number of laser shots, which is determined as an initial value, may be emitted. In another example, the preset number of laser shots may be emitted, which is determined based on the previous depth information which has been previously obtained. The emitted lasers may be reflected by the target object 330, and the reflected lasers may be detected by the image sensing device 310. The image sensing device 310 may transmit data about the lasers based on the detected lasers (e.g., data generated in response to the lasers reflected by the target object 330) to the image processing device 320. The image processing device 320 may generate the first depth for the target object 330 using the above data. In some implementations, the first depth may be generated using only the coarse histogram if necessary. For example, referring to FIG. 4a, the image sensing device 410 may transmit image data (IDATA) regarding the detected lasers to the image processing device 420. The coarse histogram generator 421 may generate the coarse histogram based on the image data (IDATA) regarding the lasers detected for coarse histogram generation. In some implementations, the coarse histogram generator 421 may generate a histogram in which bin numbers corresponding to the times-of-flight (ToF) of the detected lasers are depicted on the X-axis and count values of the detected lasers are depicted on the Y-axis. The coarse histogram generator 421 may transmit information (IC) regarding the coarse histogram to the depth information generator 423. The depth information generator 423 may generate the first depth by multiplying the speed of light by a ToF corresponding to the peak bin of the coarse histogram. Since the first depth is generated using only the coarse histogram, the first depth may be generated faster than when the first depth is generated using the fine histogram. The light source controller 424 may determine the number of laser shots to be emitted at the next time point based on the first depth information (DI). Data (DL) regarding the number of laser shots to be emitted may be transmitted to the image sensing device 410, and the image sensing device 410 may emit as many lasers as the determined number of laser shots.

In some implementations, the first depth may be generated using the fine histogram if necessary. For example, referring to FIG. 4b, the image sensing device 410 may transmit image data (IDATA) regarding detected lasers to the image processing device 420. The coarse histogram generator 421 may generate a coarse histogram based on the image data (IDATA) related to the detected lasers. In the implementations, the coarse histogram generator 421 may generate a histogram in which bin numbers corresponding to the time-of-flight (ToF) of the detected lasers are depicted on the X-axis and count values of the detected lasers are depicted on the Y-axis. Additionally, the fine histogram generator 422 may generate a fine histogram based on the generated coarse histogram and the lasers detected for fine histogram generation. In the implementations, the fine histogram generator 422 may divide the peak bin of the coarse histogram generated by the coarse histogram generator 421 into multiple bins, and may respectively assign the count values of the detected lasers to the bins, resulting in formation of the fine histogram. The fine histogram generator 422 may transmit information (IF) about the fine histogram to the depth information generator 423. The depth information generator 423 may generate the first depth by multiplying the speed of light by the ToF corresponding to the peak bin of the fine histogram. Since the first depth is generated using the fine histogram, the first depth may be more accurate than the depth generated using only the coarse histogram. The light source controller 424 may determine the number of laser shots to be emitted at the next time point based on the first depth information (DI). Data (DL) regarding the number of laser shots to be emitted may be transmitted to the image sensing device 410, and the image sensing device 410 may emit as many lasers as the determined number of laser shots.

The image processing method may use the first depth, which has been acquired at Operation S210 to determine a first shot number of first lasers for generating the coarse histogram or a second shot number of second lasers for generating the fine histogram (Operation S220). Referring to FIG. 3b, the image processing device 320 may determine the number of laser shots to be emitted, based on data obtained after detecting the lasers being reflected by the target object 330. In the example, the image processing device 320 may transmit data regarding the determined number of laser shots to the image sensing device 310.

As described above, the image processing method may determine the optimal number of laser shots for a specific depth based on depth accuracy or depth error. For example, when the light source emits 10,000 laser shots for coarse histogram generation and 25,000 laser shots for fine histogram generation, the measured depth accuracy may be about 0.435%. When the light source emits 10,000 laser shots for coarse histogram generation and 50,000 laser shots for fine histogram generation, the measured depth accuracy may be about 0.663%. When the light source emits 10,000 laser shots for coarse histogram generation and 100,000 laser shots for fine histogram generation, the measured depth accuracy may be about 0.689%. When the light source emits 20,000 laser shots for coarse histogram generation and 25,000 laser shots for fine histogram generation, the measured depth accuracy may be about 0.460%. When the light source emits 20,000 laser shots for coarse histogram generation and 50,000 laser shots for fine histogram generation, the measured depth accuracy may be about 0.576%. When the light source emits 20,000 laser shots for coarse histogram generation and 100,000 laser shots for fine histogram generation, the measured depth accuracy may be about 0.623%. When the light source emits 40,000 laser shots for coarse histogram generation and 25,000 laser shots for fine histogram generation, the measured depth accuracy may be about 0.512%. When the light source emits 40,000 laser shots for coarse histogram generation and 50000 laser shots for fine histogram generation, the measured depth accuracy may be about 0.486%. When the light source emits 40,000 laser shots for coarse histogram generation and 100,000 laser shots for fine histogram generation, the measured depth accuracy may be about 0.569%. Considering the above-described examples of depth accuracy, the image processing method may determine the number of laser shots required to generate the coarse histogram for a target object located at a specific depth to be 10,000, and may determine the number of laser shots required to generate the fine histogram for a target object located at a specific depth to be 25,000, resulting in an increase in depth measurement precision. The above numerical values are merely examples to illustrate the image processing method according to an exemplary embodiment of the disclosed technology, and other implementations are also possible.

When the light source emits 10,000 laser shots for coarse histogram generation and 25,000 laser shots for fine histogram generation, the measured depth error may be about 2.193%. When the light source emits 10,000 laser shots for coarse histogram generation and 50,000 laser shots for fine histogram generation, the measured depth error may be about 3.046%. When the light source emits 10,000 laser shots for coarse histogram generation and 100,000 laser shots for fine histogram generation, the measured depth error may be about 2.577%. When the light source emits 20,000 laser shots for coarse histogram generation and 25,000 laser shots for fine histogram generation, the measured depth error may be about 1.405%. When the light source emits 20,000 laser shots for coarse histogram generation and 50,000 laser shots for fine histogram generation, the measured depth error may be about 1.303%. When the light source emits 20,000 laser shots for coarse histogram generation and 100,000 laser shots for fine histogram generation, the measured depth error may be about 0.906%. When the light source emits 40,000 laser shots for coarse histogram generation and 25,000 laser shots for fine histogram generation, the measured depth error may be about 0.991%. When the light source emits 40,000 laser shots for coarse histogram generation and 50,000 laser shots for fine histogram generation, the measured depth error may be about 0.617%. When the light source emits 40,000 laser shots for coarse histogram generation and 100,000 laser shots for fine histogram generation, the measured depth error may be about 0.657%. Considering the above-described examples of depth errors, the image processing method may determine the number of laser shots required to generate the coarse histogram for a target object located at a specific depth to be 10,000, and may determine the number of laser shots required to generate the fine histogram for a target object located at a specific depth to be 25,000, resulting in an increase in depth measurement precision. The above numerical values are merely examples to illustrate the image processing method according to an exemplary embodiment of the disclosed technology, and other implementations are also possible.

The image processing method may also determine the optimal number of laser shots by considering the depth accuracy and/or the depth error.

The image processing method may also determine the number of laser shots by referring to a lookup table that includes optimal shot numbers for lasers to be emitted for each depth.

The image processing method may emit as many first lasers as the number of first laser shots, and may detect the first lasers reflected from the target object (Operation S230). For example, referring to FIG. 3c, the image sensing device 310 may emit as many lasers as the preset number of laser shots based on the depth obtained at a previous time point. When the emitted lasers are reflected by the target object 330, the image sensing device 310 may detect the reflected lasers through pixels and may transmit data related to the detected lasers to the image processing device 320.

The image processing method may generate the coarse histogram based on the detected first lasers (Operation S240).

The image processing method may emit as many second lasers as the number of second laser shots, and may detect the second lasers reflected by the target object (Operation S250). In other words, the image processing method may emit and detect lasers according to the number of laser shots determined based on depth information obtained at a previous time point.

The image processing method may generate a fine histogram based on the second lasers and the coarse histogram (Operation S260). As described above, the image processing method may divide the peak bin of the generated coarse histogram into multiple bins and may generate the fine histogram using the count values of the detected second lasers.

Although the foregoing examples have disclosed that image processing is performed in the order of emitting the first lasers, generating the coarse histogram, emitting the second lasers, and generating the fine histogram, the order of operations S230 to S260 may also be changed as needed. For example, the image processing method may emit and detect the first lasers, may emit and detect the second lasers, may generate the coarse histogram based on the detected first lasers, and may generate the fine histogram based on the coarse histogram and the detected second lasers.

The image processing method may determine a second depth using the fine histogram (Operation S270). In some implementations, the image processing method may calculate the depth by multiplying the time-of-flight (ToF) corresponding to the peak bin of the fine histogram by the speed of light. The image processing method may determine optimal numbers of laser shorts based on the depth, may emit lasers corresponding to the determined optimal numbers, may measure the depth using the emitted lasers, and may thus measure a depth having a higher precision than when a depth is measured by emitting lasers without considering the depth (e.g., when as many lasers as the fixed number of laser shots are emitted without changing the number of laser shots according to the depth).

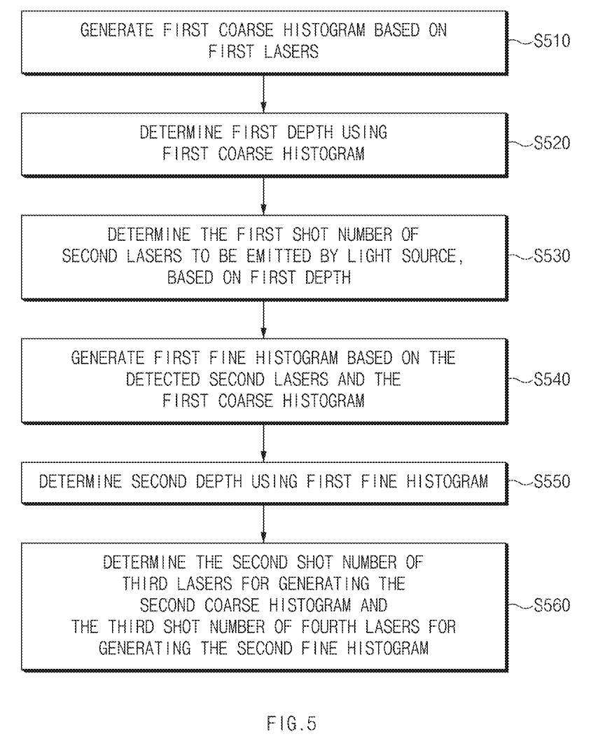

FIG. 5 is a flowchart illustrating an example of an image processing method based on some embodiments of the disclosed technology.

Referring to FIG. 5, the image processing method according to an exemplary embodiment of the disclosed technology may generate a first coarse histogram based on detected first lasers (Operation S510). In some implementations, the image processing method may emit as many first lasers as the preset number of laser shots through a light source, may detect the first lasers reflected by the target object through pixels, and may generate the first coarse histogram based on the count values and times-of-flight (ToFs) of the detected first lasers.

The image processing method may determine a first depth using the first coarse histogram (Operation S520). The image processing method may calculate the depth by multiplying the time-of-flight (ToF) corresponding to the peak bin of the first coarse histogram by the speed of light. The image processing method may determine the first depth using only the coarse histogram, rather than determining the first depth based on the fine histogram after sequential generation of the first coarse histogram and the fine histogram, so that the image processing method may acquire depth information faster than when the depth is measured by generating the fine histogram.

The image processing method may determine a first shot number of second lasers to be emitted by the light source based on the first depth (Operation S530). The second lasers may be lasers for generating the fine histogram. The first shot number may be an optimal number of laser shots for depth measurement. For example, the first shot number may be an optimal shot number of lasers determined based on depth accuracy or depth error.

The image processing method may generate a first fine histogram based on the detected second lasers and the first coarse histogram (Operation S540). Specifically, the image processing method may divide the peak bin of the first coarse histogram into multiple bins and may assign the count values of the detected second lasers to the respective bins to generate the first fine histogram.

The image processing method may determine a second depth using the first fine histogram (Operation S550). Specifically, the image processing method may calculate the second depth by multiplying the time-of-flight (ToF) corresponding to the peak bin of the first fine histogram by the speed of light.

The image processing method may determine a second shot number of third lasers for generating a second coarse histogram and a third shot number of fourth lasers for generating a second fine histogram based on the second depth (Operation S560). The second shot number and the third shot number may be determined as different values depending on depths, thereby improving precision of depth measurement. Subsequently, the image processing method may emit and detect lasers based on the determined shot numbers to measure the depth of the target object at the next time point.

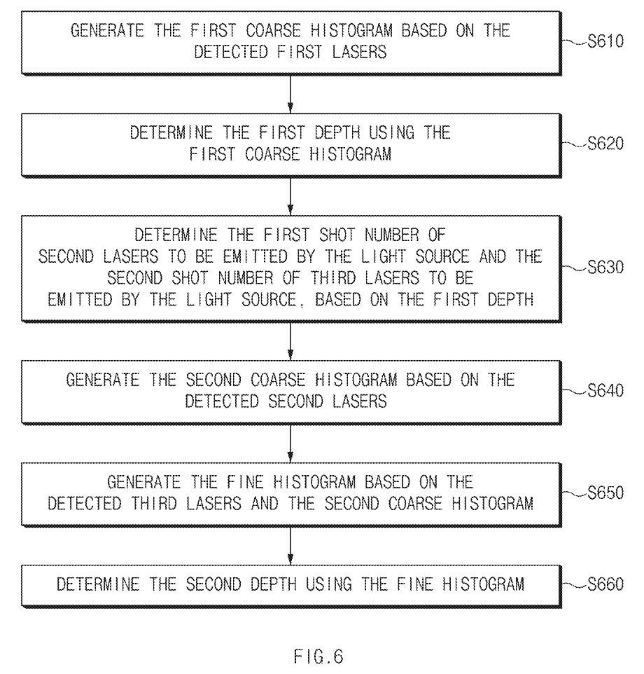

FIG. 6 is a flowchart illustrating an example of the image processing method based on some embodiments of the disclosed technology.

Referring to FIG. 6, the image processing method according to an exemplary embodiment of the disclosed technology may generate a first coarse histogram based on detected first lasers (Operation S610). Specifically, the image processing method may emit as many first lasers as the preset number of laser shots through the light source, may detect the first lasers reflected by the target object through pixels, and may generate the first coarse histogram based on the count values and time-of-flight (ToF) of the detected first lasers.

The image processing method may determine a first depth using the first coarse histogram (Operation S620). The image processing method may calculate the depth by multiplying the time-of-flight (ToF) corresponding to the peak bin of the first coarse histogram by the speed of light. The image processing method may determine the first depth using only the coarse histogram, rather than determining the first depth based on the fine histogram after sequential generation of the first coarse histogram and the fine histogram, so that the image processing method may acquire depth information faster than when the fine histogram is generated.

The image processing method may determine a first shot number of second lasers and a second shot number of third lasers to be emitted by the light source based on the first depth (Operation S630). The second lasers may be lasers for generating the second coarse histogram, and the third lasers may be lasers for generating the fine histogram. The first shot number and the second shot number may be optimal numbers of laser shots for depth measurement. For example, the first shot number and the second shot number may be determined by considering depth accuracy or depth error. The image processing method may generate the second coarse histogram based on the detected second lasers (Operation S640).

The image processing method may generate a fine histogram based on the detected third lasers and the second coarse histogram (Operation S650). Specifically, the image processing method may divide the peak bin of the second coarse histogram into multiple bins and may assign the count values of the detected third lasers to the respective bins to generate the fine histogram.

The image processing method may determine a second depth using the fine histogram (Operation S660). Specifically, the image processing method may calculate the second depth by multiplying the ToF corresponding to the peak bin of the fine histogram by the speed of light. The image processing method may obtain a relatively accurate depth by determining the second depth using the fine histogram.

Subsequently, the image processing method may determine the number of laser shots to be emitted based on the second depth, and may emit and detect lasers according to the determined shot numbers to measure the depth of the target object at the next time point.

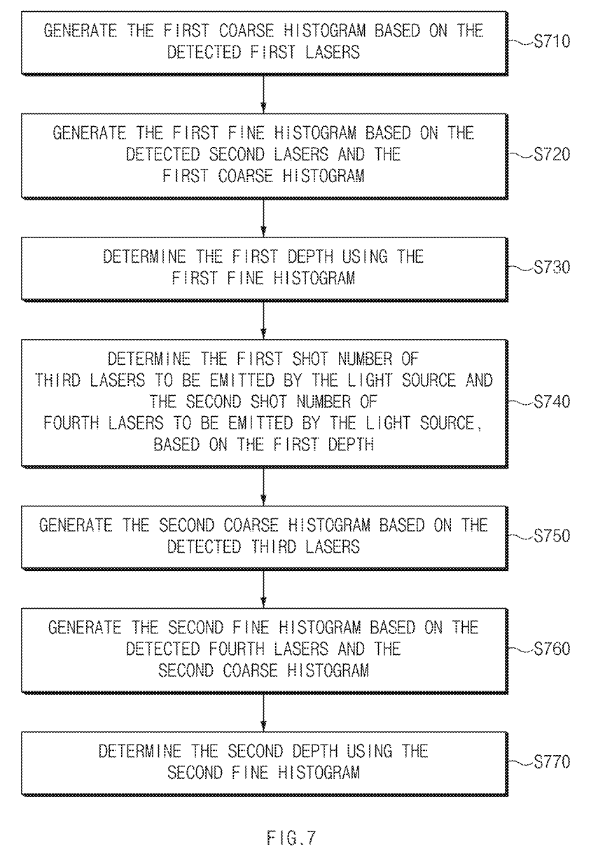

FIG. 7 is a flowchart illustrating an example of the image processing method based on some embodiments of the disclosed technology.

Referring to FIG. 7, the image processing method according to an exemplary embodiment of the disclosed technology may generate a first coarse histogram based on detected first lasers (Operation S710). Specifically, the image processing method may emit as many first lasers as the preset number of laser shots through the light source, may detect the first lasers reflected by the target object through pixels, and may generate the first coarse histogram based on the count values and times-of-flight (ToFs) of the detected first lasers.

The image processing method may generate a first fine histogram based on the detected second lasers and the first coarse histogram (Operation S720). Specifically, the image processing method may divide the peak bin of the first coarse histogram into multiple bins and may assign the count values of the detected second lasers to the respective bins to generate the first fine histogram.

The image processing method may determine a first depth using the first fine histogram (Operation S730). Specifically, the image processing method may calculate the first depth by multiplying the time-of-flight (ToF) corresponding to the peak bin of the first fine histogram by the speed of light. The image processing method may determine the first depth using the first fine histogram, so that the image processing method may acquire the depth more accurately than when the depth is determined using only the first coarse histogram.

The image processing method may determine a first shot number of third lasers and a second shot number of fourth lasers to be emitted by the light source based on the first depth (Operation S740). The third lasers may be lasers for generating a second coarse histogram, and the fourth lasers may be lasers for generating a second fine histogram. The first shot number and the second shot number may be optimal numbers of laser shots for depth measurement. For example, the first shot number and the second shot number may be determined by considering depth accuracy or depth error.

The image processing method may generate a second coarse histogram based on the detected third lasers (Operation S750).

The image processing method may generate a second fine histogram based on the detected forth lasers and the second coarse histogram (Operation S760).

The image processing method may determine a second depth using the second fine histogram (Operation S770). The image processing method may obtain a relatively accurate depth by determining the second depth using the fine histogram.

Subsequently, the image processing method may determine the number of laser shots to be emitted based on the second depth, and may emit and detect lasers according to the determined shot numbers to measure the depth of the target object at the next time point.

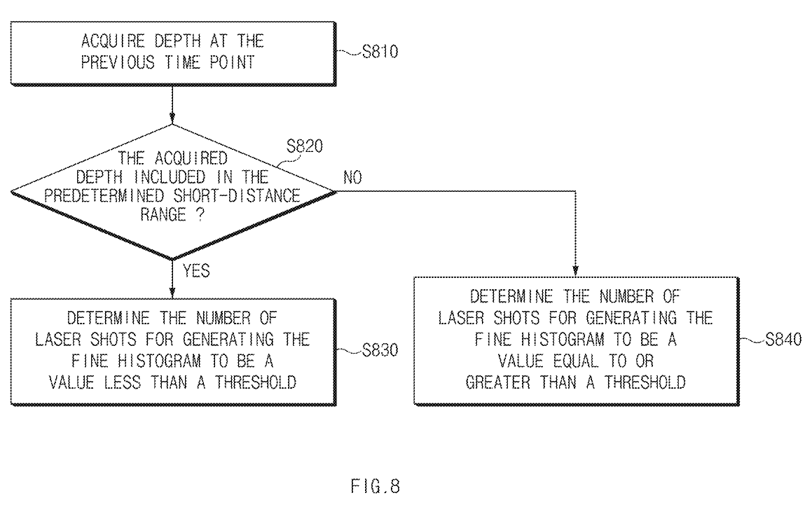

FIG. 8 is a flowchart illustrating an example of the image processing method based on some embodiments of the disclosed technology.

Referring to FIG. 8, the image processing method according to an exemplary embodiment of the disclosed technology may acquire a depth at a previous time point (Operation S810). Whereas the number of laser shots to be emitted is determined based on the depth, a depth of the target object at the current time point has not yet been measured, so that the image processing method may determine the number of laser shots using the depth obtained at the previous time point.

The image processing method may determine whether the acquired depth is included in a predetermined short-distance range (Operation S820). For example, the image processing method may determine whether the acquired depth is within a range from 40 centimeters to 8 meters, without being limited thereto.

When the acquired depth is included in the predetermined short-distance range, the image processing method may determine the number of laser shots for generating the fine histogram to be less than a threshold (Operation S830).

When the acquired depth is not included in the predetermined short-distance range (i.e., when the acquired depth is included in a predetermined long-distance range), the image processing method may determine the number of laser shots for generating the fine histogram to be equal to or greater than a threshold (Operation S840). Assuming that the predetermined long-distance range is 8 meters or more, when the acquired depth is 9 meters, the image processing method may determine the number of laser shots for generating the fine histogram to be a value equal to or greater than the threshold. However, the above-described numerical values are merely examples for convenience of description and better understanding of the disclosed technology, and other implementations are also possible.

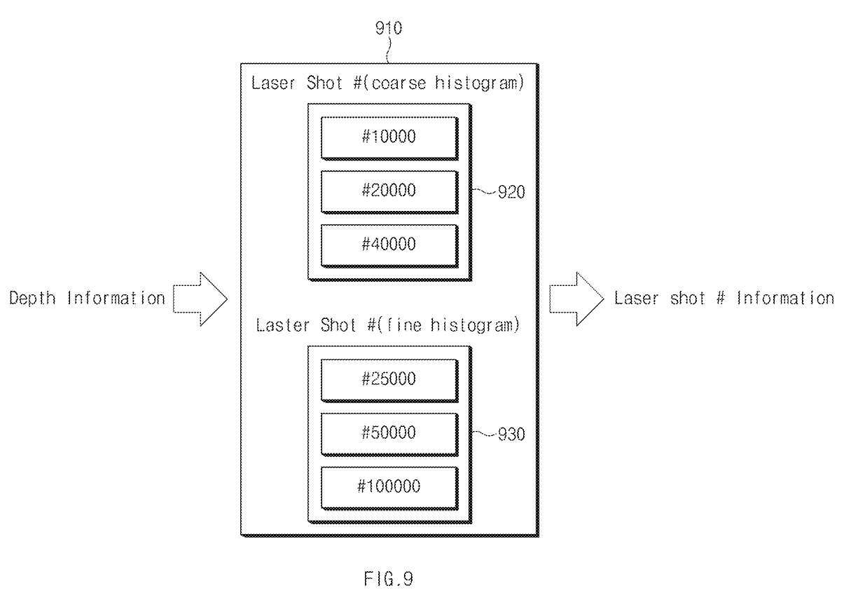

FIG. 9 is a conceptual diagram illustrating an example of the image processing method based on some embodiments of the disclosed technology.

Referring to FIG. 9, the light source controller 910 may determine the number of laser shots to be emitted by the image sensing device based on depth information using stored lookup tables (920, 930). Specifically, the light source controller 910 may generate information about at least one of the number of laser shots for generating the coarse histogram corresponding to the depth information and the number of laser shots for generating the fine histogram corresponding to the depth information by referring to the stored lookup tables (920, 930). For example, in a situation where the depth of the target object is 6 meters, when the lookup table 920 indicates 10,000 laser shots required to generate the coarse histogram corresponding to 6 meters, and the lookup table 930 indicates 25,000 laser shots required to generate the fine histogram corresponding to 6 meters, the light source controller 910 may determine 10,000 and 25000 as the optimal numbers of laser shots to be emitted toward the target object, respectively, and may transmit information regarding such laser shot numbers (10000, 25000) to the image sensing device. The image sensing device may emit lasers toward the target object according to the received information regarding the number of laser shots. The image processing device according to the exemplary embodiment of the disclosed technology may determine the optimal number of laser shots to be emitted toward the target object, thereby increasing the accuracy of depth measurement.

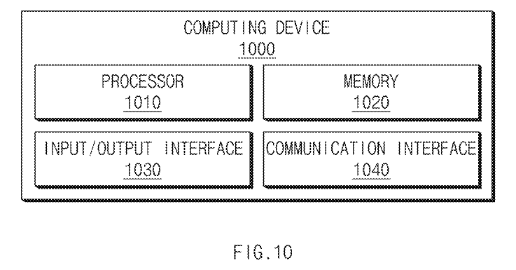

FIG. 10 is a block diagram showing an example of a computing device 1000 corresponding to the image processing device 100 of FIG. 1.

Referring to FIG. 10, the computing device 1000 may represent an embodiment of a hardware configuration for performing the operation of the image processing device 200 of FIG. 1.

The computing device 1000 may be mounted on a chip that is independent from the chip on which the image sensing device is mounted. In one embodiment, the chip on which the image sensing device is mounted and the chip on which the computing device 1000 is mounted may be implemented in one package, for example, a multi-chip package (MCP), other implementations are also possible.

In some implementations, the internal configuration or arrangement of the computing device 1000 and the image sensing device may vary depending on the embodiment. For example, at least a portion of the image sensing device may be included in the computing device 1000. Alternatively, at least a portion of the computing device 1000 may be included in the image sensing device. In this case, at least a portion of the computing device 1000 may be mounted together on a chip on which the image sensing device is mounted.

The computing device 1000 may include a processor 1010, a memory 1020, an input/output (I/O) interface 1030, and a communication interface 1040.

The processor 1010 may process data and/or instructions required to perform the operations of the components of the image processing device 200 described in FIG. 1. In the example, the processor 1010 may refer to the image processing device 200, but other implementations are also possible.

The memory 1020 may store data and/or instructions required to perform operations of the components of the image processing device 200, and may be accessed by the processor 1010. For example, the memory 1020 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), etc.), EEPROM (Electrically Erasable PROM), flash memory, etc.).

That is, the computer program for performing the operations of the image processing device 200 disclosed in this document is recorded in the memory 1020 and executed and processed by the processor 1010, thereby implementing the operations of the image processing device 200.

The input/output (I/O) interface 1030 is an interface that connects an external input device (e.g., keyboard, mouse, touch panel, etc.) and/or an external output device (e.g., display) to the processor 1010 to allow data to be transmitted and received.

The communication interface 1040 is a component that can transmit and receive various data with an external device (e.g., an application processor, external memory, etc.), and may be a device that supports wired or wireless communication.

As is apparent from the above description, the image processing device based on some embodiments of the disclosed technology may improve depth measurement accuracy by emitting lasers with different numbers of laser shots according to depth information.

The image processing device based on some embodiments of the disclosed technology may generate depth information using a coarse histogram or a fine histogram.

The image processing device based on some embodiments of the disclosed technology may emit lasers based on the determined number of laser shots, and may calculate a depth by detecting the emitted lasers.

The image processing device based on some embodiments of the disclosed technology may determine an optimal number of laser shots for generating a coarse histogram and an optimal number of laser shots for generating a fine histogram.

The embodiments of the disclosed technology may provide a variety of effects capable of being directly or indirectly recognized through the above-mentioned patent document.

Those skilled in the art will appreciate that the disclosed technology may be carried out in other specific ways than those set forth herein. In addition, claims that are not explicitly presented in the appended claims may be presented in combination as an embodiment or included as a new claim by a subsequent amendment after the application is filed.

Although a number of illustrative embodiments have been described, it should be understood that modifications and enhancements to the disclosed embodiments and other embodiments can be devised based on what is described and/or illustrated in this patent document.

What is claimed is:

1. An image processing device, comprising:
a coarse histogram generator configured to receive first image data generated in response to light of first light pulses that is directed to illuminate, and is reflected from, a target object and generate a first coarse histogram based on the first image data;
a depth information generator in communication with the coarse histogram generator to receive the first coarse histogram and configured to generate first depth information based on the first coarse histogram; and
a light source controller in communication with the depth information generator to receive the first depth information and configured to determine a first shot number of second light pulses that are to be directed to the target object based on the first depth information.

2. The image processing device according to claim 1, further comprising:
a fine histogram generator configured to generate a first fine histogram based on the first coarse histogram and second image data generated in response to the second light pulses reflected from the target object,
wherein
the depth information generator generates second depth information using the first fine histogram.

3. The image processing device according to claim 2, wherein the light source controller is configured to:
determine a second shot number of third light pulses to be directed to the target object and a third shot number of fourth light pulses to be directed to the target object based on the second depth information.

4. The image processing device according to claim 3, wherein:
the coarse histogram generator is configured to generate a second coarse histogram based on third image data generated in response to the third light pulses reflected from the target object; and
the fine histogram generator is configured to generate a second fine histogram based on the second coarse histogram and fourth image data generated in response to the fourth light pulses reflected from the target object.

5. The image processing device according to claim 4, wherein the depth information generator is configured to:
generate third depth information based on the second fine histogram.

6. The image processing device according to claim 3, wherein the light source controller is configured to:
determine the second shot number of the third light pulses to be a value equal to or greater than a first threshold, upon determining that the target object is located within a predetermined long-distance range based on the second depth information.

7. The image processing device according to claim 1, wherein the light source controller is configured to:
determine the first shot number of the second light pulses to be a value less than a second threshold, upon determining that the target object is located within a predetermined short-distance range based on the first depth information; and
determine the first shot number of the second light pulses to be a value equal to or greater than the second threshold, upon determining that the target object is located within a predetermined long-distance range based on the first depth information.

8. The image processing device according to claim 1, wherein the light source controller is configured to:
determine the first shot number of the second light pulses according to the first depth information by referring to a pre-stored lookup table.

9. The image processing device according to claim 1, wherein the light source controller is configured to:
determine the first shot number of the second light pulses based on depth accuracy or depth error.

10. An image processing device comprising:
a coarse histogram generator configured to receive first image data generated in response to detection of reflection of first light pulses generated by a light source that is directed to illuminate, and is reflected from, a target object and generate a first coarse histogram based on the first image data;
a fine histogram generator in communication with the coarse histogram generator to receive the first coarse histogram and configured to generate a first fine histogram based on the first coarse histogram and second image data generated in response to detection of reflection of second light pulses generated by the light source from the target object;
a depth information generator in communication with the fine histogram generator to receive the first fine histogram and configured to generate first depth information based on the first fine histogram; and
a light source controller in communication with the depth information generator to receive the first depth information and configured to determine a first shot number of third light pulses and a second shot number of fourth light pulses based on the first depth information.

11. The image processing device according to claim 10, wherein:
the coarse histogram generator is configured to generate a second coarse histogram based on third image data generated in response to the third light pulses reflected from the target object; and
the fine histogram generator is configured to generate a second fine histogram based on the second coarse histogram and fourth image data generated in response to the fourth light pulses reflected from the target object.

12. The image processing device according to claim 11, wherein the depth information generator is configured to:
generate second depth information based on the second fine histogram.

13. The image processing device according to claim 10, wherein the light source controller is configured to:
determine the first shot number of the third light pulses to be a value equal to or greater than a first threshold, upon determining that the target object is located within a predetermined long-distance range based on the first depth information.

14. The image processing device according to claim 10, wherein the light source controller is configured to:
determine the second shot number of the fourth light pulses to be a value less than a second threshold, upon determining that the target object is located within a predetermined short-distance range based on the first depth information; and
determine the second shot number of the fourth light pulses to be a value equal to or greater than the second threshold, when the first depth information is included in a predetermined long-distance range.

15. The image processing device according to claim 10, wherein the light source controller is configured to:
determine the first shot number of the third light pulses to be emitted by the light source and the second shot number of the fourth light pulses to be emitted by the light source, based on a pre-stored lookup table.

16. The image processing device according to claim 10, wherein the light source controller is configured to:
determine the first shot number of the third light pulses to be emitted by the light source and the second shot number of the fourth light pulses to be emitted by the light source, based on depth accuracy or depth error.

17. An image processing device, comprising:
a coarse histogram generator configured to receive first image data generated in response to first light pulses reflected from a target object and generate a first coarse histogram based on first image data;
a depth information generator in communication with the coarse histogram generator to receive the first coarse histogram and configured to generate first depth information based on the first coarse histogram; and
a light source controller in communication with the depth information generator to receive the first depth information and configured to determine a first shot number of second light pulses and a second shot number of third light pulses based on the first depth information.

18. The image processing device according to claim 17, wherein the coarse histogram generator is configured to:
generate a second coarse histogram based on second image data generated in response to the second light pulses reflected from the target object.

19. The image processing device according to claim 18, further comprising:
a fine histogram generator configured to generate a fine histogram based on the second coarse histogram and third image data generated in response to the third light pulses reflected from the target object.

20. The image processing device according to claim 19, wherein the depth information generator is configured to:
generate second depth information based on the fine histogram.
